(19) United States
(12) Patent Application Publication
(10) Pub. No.: US 2016/0350058 A1
(43) Pub. Date: Dec. 1, 2016

(54) WIRELESS DISPLAY ADAPTER DEVICE

(71) Applicant: Intel Corporation, Santa Clara, CA (US)

(72) Inventors: Jianfang Zhu, Portland, OR (US); Xintian E. Lin, Palo Alto, CA (US); Gary C. Huang, San Jose, CA (US); Sayan Lahiri, Hillsboro, OR (US)

(73) Assignee: Intel Corporation, Santa Clara, CA (US)

(21) Appl. No.: 15/089,395

(22) Filed: Apr. 1, 2016

Related U.S. Application Data
(60) Provisional application No. 62/169,391, filed on Jun. 1, 2015.

(51) Int. Cl. G06F 3/14; H04N 21/41; H04N 21/4363; G09G 5/12; H04N 21/436

(52) U.S. Cl. CPC G06F 3/1454; G09G 5/12; H04N 21/43615; H04N 21/43635; H04N 21/43637; H04N 21/4126; G09G 2370/16; G09G 2370/12

(57) ABSTRACT

The present disclosure relates to a wireless display adapter device including at least one processor and at least one memory element, wherein the wireless display adapter device is configured to: transmit a beacon signal from the wireless display adapter device, wherein the wireless display adapter device is in a sleep mode of operation; receive a connection request from a user device; initiate wake up of the wireless display adapter device from the sleep mode to an active mode responsive to receiving the connection request from the user device; and establish a connection between the wireless display adapter device and the user device using a wireless connection.

### RELATED APPLICATION

This application claims the benefit of priority under 35 U.S.C. §119(e) to U.S. Provisional Application No. 62/169,391, entitled “WIRELESS DISPLAY ADAPTER DEVICE” filed in the U.S. Patent Office on Jun. 1, 2015, which is hereby incorporated by reference in its entirety.

### TECHNICAL FIELD

This application relates to the field of computing, and more particularly to a wireless display adapter device.

### BACKGROUND

Wireless is currently an inevitable trend and lifestyle for everything. User demand is high to wirelessly play content from mobile devices such as laptops, tablets and phones, for both business and consumer usages. A number of screen mirroring or wireless display products are available, including TV boxes/dongles and streaming devices. However, these existing solutions all have their limitations and leave much to be desired for many usage scenarios. Accordingly, there is still a demand to develop a solution to share content anywhere quickly.

Existing solutions provide a number of pain points for a user to experience in order to share content, such as video. Pain points which users may be required to experience include: 1) For business users, the necessity to carry a number of converters/connectors, such as High-Definition Multimedia Interface (HDMI), DisplayPort (DP), Digital Visual Interface (DVI), Video Graphics Array (VGA), etc, for compatibility purposes. Different mobile devices may have different I/O ports, but compatible adapters may be missing in the presentation environment such as a conference room. Carrying a high number of dongles is troublesome and too many wires create clutter. 2) In the presentation environment such as a conference room, wires dictate the presenter's seat and require switching seats if there are multiple presenters. 3) Existing conference room infrastructures only assume presentations from laptops, limiting the usage of other mobile devices. 4) Plugging in and connecting to the A/V display device takes time away from the meeting. 5) WLAN access could be cumbersome or WiFi speed could be slow or unstable in some scenarios, so sharing or streaming will be limited if relying on WLAN connections, e.g. when meeting at client sites or staying at hotels.

Some existing wireless display devices may address some of these issues, but may require a painful process of searching, user identification and connection, which easily takes twenty seconds or more to accomplish.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates an embodiment of a system for streaming content from a user device to a display device using a wireless display adapter device;

FIG. 2 illustrates a first flow showing establishment of a connection from user device to the wireless display adapter device;

FIG. 3 illustrates a second flow showing an almost instant connection from the wireless display adapter device;

FIG. 4 illustrates hardware components of a wireless display adapter device according to one particular embodiment;

FIG. 5 illustrates an embodiment of the wireless display adapter device of the system of FIG. 1; and

FIG. 6 illustrates a simplified flow chart showing operations associated with the wireless display adapter device in accordance with one embodiment.

### DETAILED DESCRIPTION OF EXAMPLE EMBODIMENTS

One or more embodiments described herein provide users with a fully contained wireless display experience without requiring extra plugs or dongles to be carried by a user for content presentations such as meeting room projector/flat panel, hotel room, family room HDTV entertainment presentations or any other desired presentation environment.

Various embodiment described herein provide for a wireless display adapter device having a compact, portable, self powered design to address one or more of the aforementioned pain points for users. One or more embodiments provides a clean and simple connection model having a power-on connection to a personal user device such as a smart phone, tablet computer, or laptop computer. In accordance with various embodiments, the wireless display adapter device and user device (laptop/tablet/phone, etc.) can initiate a connection between one another when powering up. In particular embodiments, the connection can be made before the wireless display adapter device is connected to a display device (such as a projector and/or television) which makes the perceived user experience instant (i.e. essentially a zero second connection). Various embodiments enable users to present and share content anywhere wirelessly and instantly. Particular embodiments may use Intel® Wireless Display (WiDi) and/or Pro-WiDi technology to connect between the wireless display adapter device and the display device.

In accordance with various embodiments, a wireless display adapter device includes (Intel® WiDi and Pro-WiDi technology) a battery and multiple connectors to provide users a fully contained wireless display experience (e.g., requiring no wall plugs or USB dongles) for providing content presentations such as meeting room projector presentations and hotel room or family room HDTV entertainment. In one or more embodiments, the wireless display adapter device is a personal device allowing a user to customize a home screen, device name and other settings. In one or more embodiments, the wireless display adapter device supports auto-discovery, instant connection, stable streaming and meeting management for multiple presenters. In one or more embodiments, the wireless display adapter device is designed with a slim and portable for factor enabling easy portability.

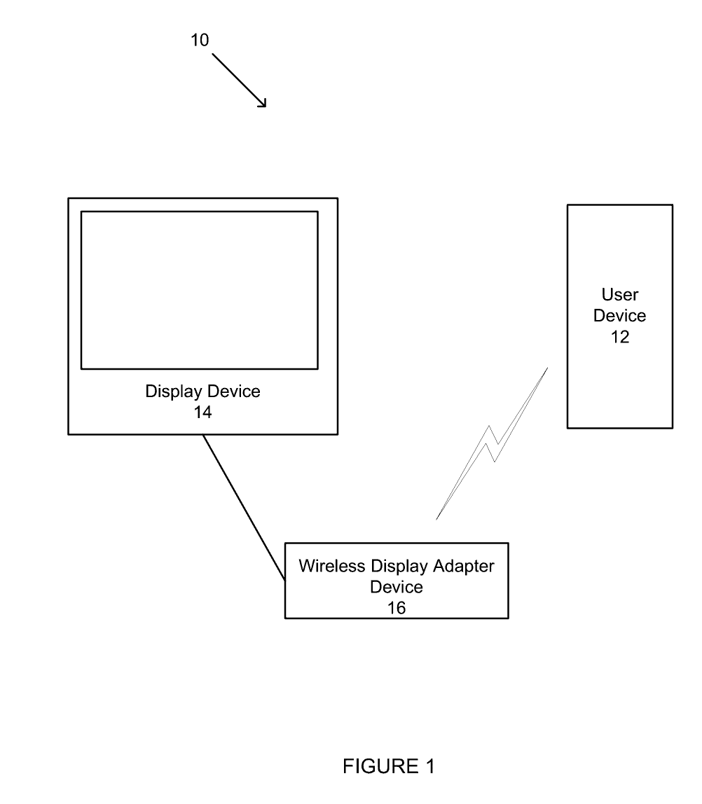

FIG. 1 illustrates an embodiment of a system 10 for streaming content from a user device 12 to a display device 14 using a wireless display adapter device 16. In the embodiment illustrated in FIG. 1, user device 12 and the wireless display adapter 16 are in communication via a wireless connection such as a Bluetooth Low Energy (BLE) connection, a Bluetooth connection, or a WiFi connection, and wireless display adapter device 16 is coupled to display device 14 via a wired connection such as an HDMI and/or VGA connection. In accordance with various embodiments, content (such as a video presentation) is streamed from the user device 12 via the wireless connection to wireless display adapter device 16, and wireless display adapter 16 outputs the streamed content received from the user device 12 to the display device 14 using the wired connection. In one or more embodiments, display device 14 may be configured to display the streamed content within a screen of the display device 14. In one or more embodiments, user device 12 may include a smart phone, a tablet computer, a laptop computer, a laptop computer, or any other suitable computing or communication device. In one or more embodiments, display device 14 may include a monitor, a television, a projector, or any other suitable display device.

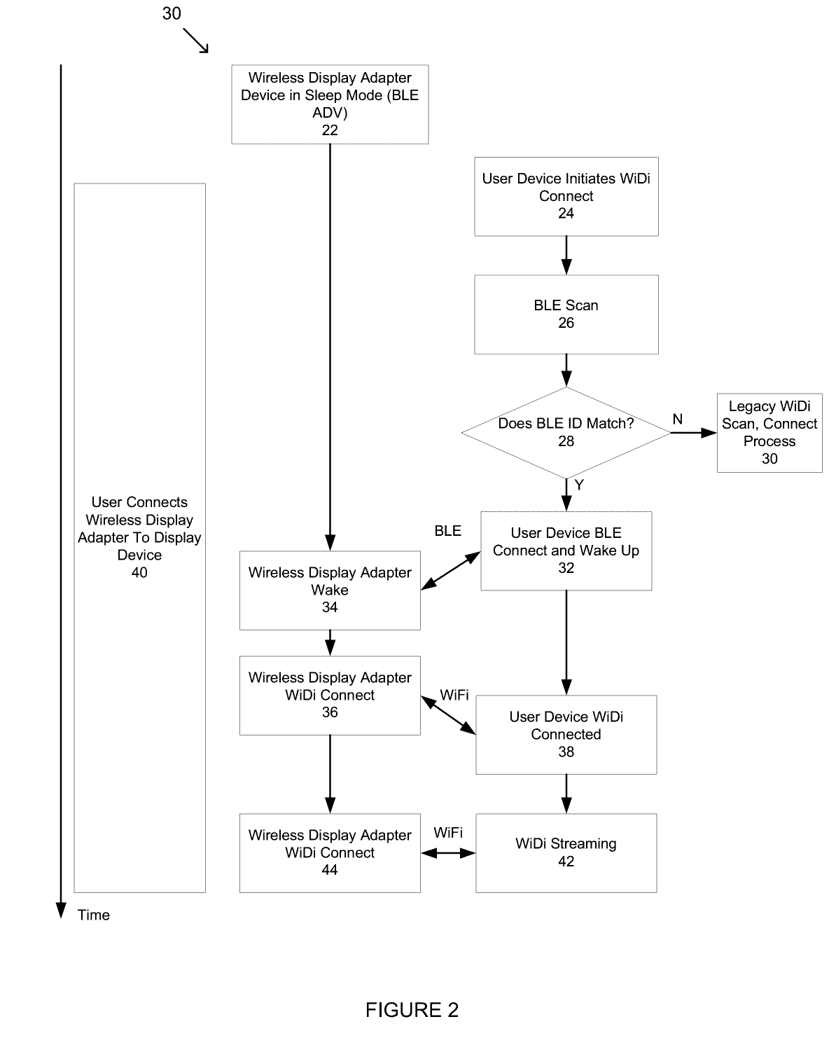

FIG. 2 illustrates a first flow 20 showing establishment of a connection from user device 12 to wireless display adapter device 16. In the start of the flow in 22, wireless display adapter device 16 is in a sleep state/mode in which a Bluetooth Low Energy (BLE) advertising mode is enabled. In the BLE advertising mode, wireless display adapter device 16 periodically transmits a beacon signal including advertising information which may include a BLE ID associated with wireless display adapter device 16. In 24, user device 12 initiates a WiDi connect operation. WiDi is a technology that allows streaming of video and other content from a user device to a display. In 26, user device 12 uses a BLE scan operation to discover the wireless display adapter device 16 by receiving the beacon signal transmitted from wireless display adapter 16. In 28, user device 12 determines whether the BLE ID received in the beacon signal matches a BLE ID associated with the wireless display adapter device 16. If the BLE ID does not match, in 30 the user device 12 initiates a legacy WiDi scan and connect process. If the BLE ID matches, in 32, user device 12 connects to wireless display adapter device 16 using a BLE connection request to initiate wake up of wireless display adapter device 16 from the sleep mode to an active mode. In 34, wireless display adapter device 16 wakes up in response to the BLE connection request. In particular embodiments, this process can be performed in less than 500 ms depending on the advertisement frequency (typically 100 ms to 1 s). Although the embodiment illustrated in FIG. 2 is shown as using a BLE beacon to facilitate discovery of the wireless display adapter device 16 via the user device 12, it should be understood that in other embodiments any type of wireless connection may be used.

As further illustrated in FIG. 2, in 36, wireless display adapter device 16 initiates a WiDi connect procedure using a WiFi connection with user device 12 after powering up, and in 38 user device 12 is connected to wireless display adapter device 16 via the WiFi connection. In particular embodiments, this process may take approximately five seconds. Although the embodiment illustrated in FIG. 2 is shown as using a WiFi connection to facilitate streaming of content between the user device 12 and the wireless display adapter device 16, it should be understood that in other embodiments any type of wireless connection may be used.

In 40, the user may then establish a wired connection between wireless display adapter device 16 and display device 14 (such as a TV and/or projector). When the user finishes connecting the wireless display adapter device 16 to the display device 14, the output is ready and the user may begin immediately streaming content, such as video, from the user device 12 to the display device 14 via the wireless display adapter device 16. In 42, user device 42 begins wirelessly streaming content to wireless display adapter device 16. In 44, wireless display adapter device 16 streams the content received from user device 12 to display device 14 using the wired connection. It should be noted that in other embodiments that after BLE wakeup, a WiDi connection can be initiated from the user device 16. In particular embodiments, a “power good” message from the wireless display adapter device 16 over BLE may be used as a trigger mechanism (not shown) to initiate the connection.

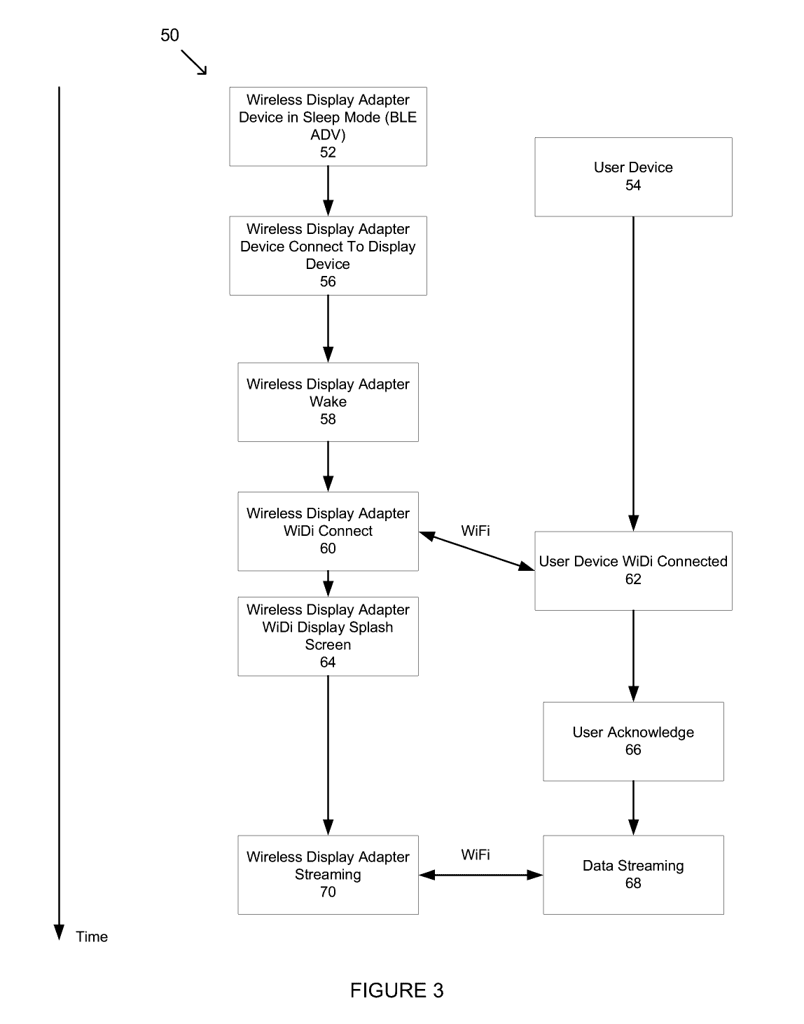

FIG. 3 illustrates a second flow 50 showing an almost instant connection from the wireless display adapter device 16. A concern that may exist of initiating a WiDi session from wireless display adapter device 16 is that of privacy. Therefore, in accordance with various embodiments, the initial display may be an insensitive splash screen. Only after user acknowledgement on the user device, does the streaming start. In any case, the time consuming part of discovery and connecting is finished in the process and user perception is that of an almost instant experience, especially compared to existing streaming products. In the start of the flow in 52, wireless display adapter device 16 is in a sleep state/mode in which a BLE advertising mode is enabled. In 54, user device 12 is waiting for establishment of a connection with wireless display adapter device 16. In 56, wireless display adapter device 16 is connected to display device 14 (e.g., a TV/projector). In 58, wake up of the wireless display adapter device 16 is initiated. Upon wakeup of wireless display adapter device 16, wireless display adapter device 16 initiates a connection with user device 12 using a WiFi connection using a WiDi connection procedure in 60. In 62, user device 12 is WiDi connected to wireless display adapter device 16. In 64, wireless display adapter device 16 initially displays a splash screen in order to protect from any private information that may be currently displayed by the user device 12 until receiving a user acknowledgement from user device 12 in 66. In 68, content, such as video, is wirelessly streamed from user device 12 to wireless display adapter 16. In 70, the content received from user device 12 is then streamed to the display device 14.

In accordance with various embodiments, wireless display adapter device 16 is a self-powered portable adapter to place users in control of how they connect and share streaming content anywhere, and/or allow personalization of home screen, device name, and other settings. After a first time pairing, wireless display adapter device 16 can automatically recognize and connect to the user's paired user mobile device in one or more embodiments. Various embodiments allow users to move around the presentation environment (e.g., a room) freely without wire/power outlet constrains. One or more embodiments may provide for flexibility for all mobile devices to be used to present and stream content for both business/work and entertainment purposes. Some embodiments provide for users the ability to allow other people to connect to the wireless display adapter device and share content through a seamless switch.

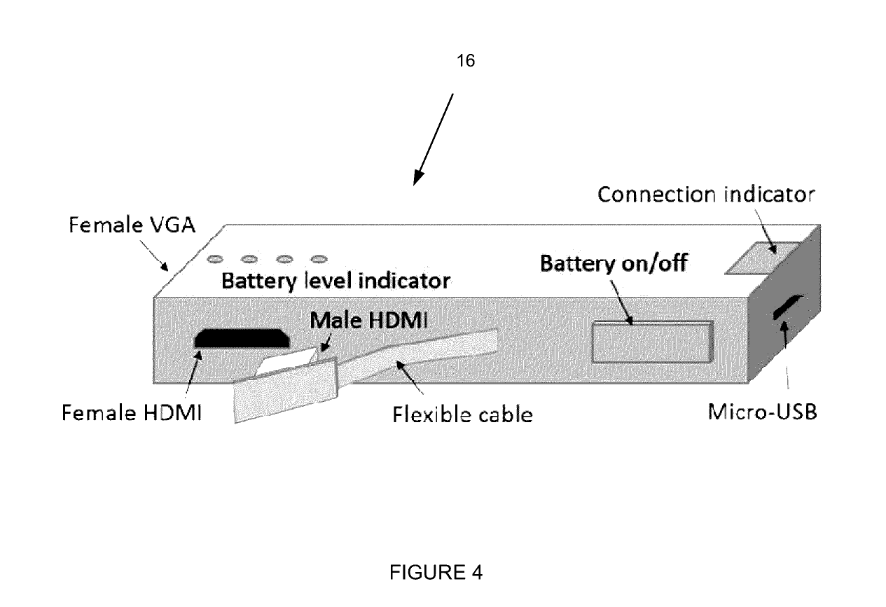

FIG. 4 illustrates hardware components of a wireless display adapter device 16 according to one particular embodiment. The wireless display device 16 may include one or more of the following main hardware components: system on a chip (SoC) including at least one processor, a WiFi chip, a Bluetooth chip, a memory, a rechargeable battery, female HDMI & VGA output connectors, a flat flexible USB charging cable, etc. Particular embodiments may support Intel® WiDi/Pro-WiDi software and firmware. Depending on the usage, additional accessories provided in a product package or pouch may include male to male HDMI, VGA converters, etc. One or more embodiments may include a battery on/off switch or the wireless display adapter device 16 may be configured to be turned on/off when a video output (e.g., HDMI/VGA) is plugged in or unplugged from the display device 14. One or more embodiments may include a battery energy indicator, low battery warning flash and HDMI/VGA connection indicator. Various embodiments may cover one or more of the following example use cases: a) present/share using cables on a conference table (male HDMI or VGA) in the scenario of projector on the conference table or attached to a ceiling; b) present/share by plugging into the back of a projector; c) present/share using cables on a table (male HDMI or VGA) in the scenario of a flat panel TV mounted on a wall in a meeting rooms; and d) share/stream by plugging into the back of a TV in a hotel or family room.

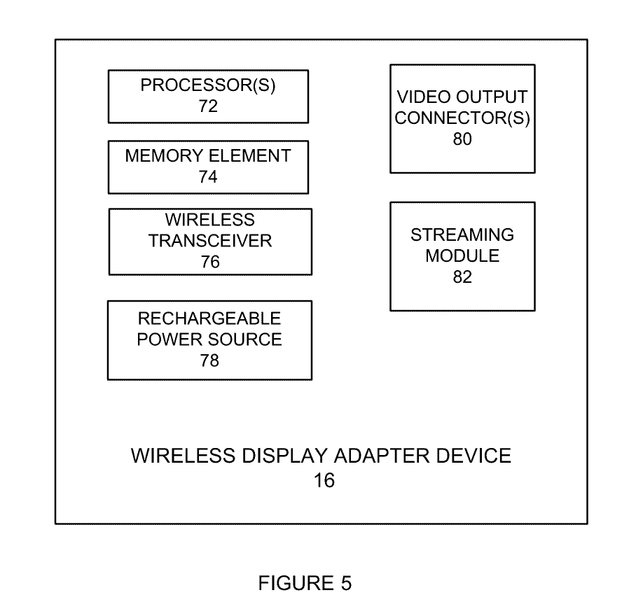

FIG. 5 illustrates an embodiment of wireless display adapter device 16 of the system 10 of FIG. 1. In the particular embodiment illustrated in FIG. 5, wireless display adapter device 16 includes one or more processor(s) 72, a memory element 74, a wireless transceiver 76, a rechargeable power source 78, one or more video output connector(s) 80, and a streaming module 82. Processor(s) 72 is configured to execute software instructions to perform various operations of wireless display adapter device 16 as described herein. Processor(s) 72 may be any type of processor, such as a micro-processor, an embedded processor, a digital signal processor (DSP), a network processor, or other device to execute code. Although only one processor(s) 72 is illustrated in FIG. 5, it should be understood that wireless display adapter device 16 may include more than one processor in some embodiments. Memory element 74 may be configured to store software instructions and data associated with wireless display adapter device 16. Memory element 74 may be any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 10 could be provided in any database, register, queue, table, cache, control list, or other storage structure, all of which can be referenced at any suitable timeframe. Any such storage options may also be included within the broad term ‘memory element’ as used herein.

Wireless transceiver 76 is configured to enable wireless communication with user device 12. In particular embodiments, wireless transceiver 76 may include one or more of a Bluetooth transceiver, a Wi-Fi transceiver, a 3G and/or 4G transceiver, an NFC transceiver, ultrasound, or any other suitable wireless transceiver. In one or more embodiments, wireless transceiver 76 is configured to transmit beacon signals to, establish a connection with, and receive content from user device 12. Rechargeable power source 78 is a power source, such as a battery, that is rechargeable through a connection such as a USB connection. In alternative embodiments, wireless display adapter device 16 may be powered by an external power source. Video output connector(s) 80 include one or more video output connectors to couple wireless display adapter device 16 to display device through a wired connection. In particular embodiments, video output connector(s) 80 may include one or more of an HDMI connector, a VGA connector, and a DVI connector.

Streaming module 82 includes software and/or hardware to facilitate the streaming functions of wireless display adapter device 16 as described herein such as receiving streaming content from user device 12 and sending the content to display device 14.

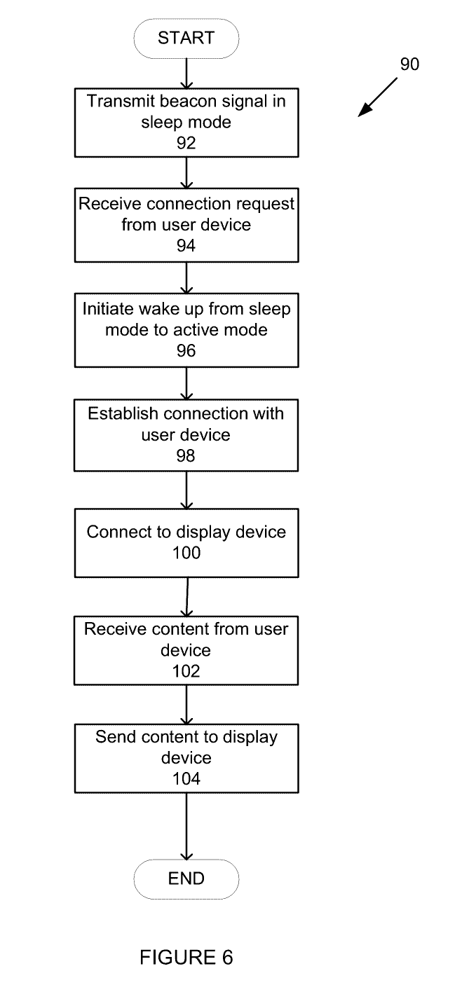

FIG. 6 illustrates a simplified flow chart 90 showing operations associated with wireless display adapter device 16 in accordance with one embodiment. In 92, wireless display adapter device 16 transmits a beacon signal, wherein wireless display adapter device 16 is in a sleep mode of operation. In 94, wireless display adapter device 16 receives a connection request from a user device. In 96, wake up of the wireless display adapter device from the sleep mode to an active mode is initiated responsive to receiving the connection request from user device 12. In 98, a connection is established between wireless display adapter device 16 and user device 12 using a wireless connection.

In 100, wireless display adapter device 16 is connected to display device 14. In 102, wireless display adapter device 16 receives content from user device 12. In 104, wireless display adapter device 16 sends the content to display device 14.

In a particular embodiment, the beacon signal further includes include an identifier associated with wireless display adapter device. In still another particular embodiment, the beacon signal is a Bluetooth low energy signal. In another particular embodiment, the connection is a WiFi connection. In still another particular embodiment, the connection between the wireless display adapter device and the display device is a wired connection. In another particular embodiment, the wired connection is one or more of a High-Definition Multimedia Interface (HDMI) connection, a DisplayPort (DP) connection, a Digital Visual Interface (DVI), and a Video Graphics Array (VGA) connection.

Various embodiments may provide for a wireless display adapter device 16 that is highly integrated, compact and portable. One or more embodiments may provide users with a nearly instant connection with display screens in, for example, a conference, hotel or family room. One or more embodiments may support smooth and stable presentation/streaming without requiring a WLAN connection or bulky cables. One or more embodiments may be self-powered with a flat flexible USB charging cable for easy charge and carrying. One or more embodiments may offer a private screen before a user starts sharing content. In various embodiments, the wireless display adapter device 16 is provided as a personal device that only needs pairing once with user device 12 associated with a particular user such as a laptop, tablet and/or phone, and then can automatically connect to a favorite available device when it is powered on. More importantly, in various embodiments wireless display adapter device 16 can realize an instant connection, which hasn't been achieved by existing WiDi dongles or other display adapters. In one example implementation that realizes such instant connection: 1) the wireless display adapter device BLE is in advertisement mode which sends beacons periodically (e.g., once per second) when the system is off. In a particular embodiment, the average power drain is approximately 10 uA in this mode allowing a battery pack (e.g. a 2000 mAh battery pack) to provide a long batter life (e.g., more than 20 years of battery life). 2) the user device (e.g., laptop) starts an application (such as a WiDi app), which triggers the user device BLE connection to wireless display adapter device 16. The BLE connection initiates turning on of a main CPU of the wireless display adapter device 16 and initiates a WiFi connection between user device 12 and wireless display adapter device 16. 3) The user physically connects an output connection of wireless display adapter device 16 to an input of display device 12 and starts presenting content. Accordingly, content, such as a video presentation, is streamed from user device 12 to wireless display adapter device 16 using the WiFi connection between user device 12 and wireless display adapter device 16, and the wireless display adapter device 16 provides the content to display device 14 via the connection between wireless display adapter device 16 and display device 14. Display device 14 may then display the content streamed from user device 12 upon one or more screens of display device 14.

In particular embodiments, wireless display adapter device 16 has meeting management capability to allow other people to connect and share. In particular embodiments, a software application for use with wireless display adapter device 16 may be simple and elegant with a few options including a first-time set-up option, a personalize home screen option, device name option, “start sharing” option, “disconnect” option and “accept request” option to allow others to share. Particular embodiments may work across operating systems such as Windows and Android.

Various embodiments of wireless display adapter device 16 may include a host of unique design variations including:

1) Built-in connector choices can vary depending upon particular user scenarios in various embodiments. For example, if a major usage is to connect to a TV, a male HDMI output connector can be built into wireless display adapter device 16 instead of a female VGA output. In particular embodiments, to reduce the number of accessories in a product package or pouch, more connectors can be integrated into the design of wireless display adapter device 16.

2) The placement of built-in connectors can vary in various embodiments. The wireless display adapter device design shown in FIG. 4 has two connectors on two ends. For different form factors, in different embodiments two or more connectors if necessary can be placed on the same end or placed on two, three or four sides of the device.

3) The manner to build in connectors can vary in various embodiments. For example, in a particular embodiment a “dongle-on-dongle” design can be used to incorporate male-to-male HDMI and VGA into the wireless display adapter device. Specifically, a compact male-to-male HDMI or VGA converter can be plugged into the female HDMI connector or the VGA connector in FIG. 4 as part of the wireless display adapter device. If they are not needed, a user may unplug them to use the female ports; after usage, the user may then plug them back in. In addition, flat flexible cable can also be used to integrate extendable male HDMI into the wireless display adapter device. With such variations, the wireless display adapter device may function as a “Swiss army knife”, which is convenient to carry and works for all scenarios.

4) Various embodiments may provide for the combination of a battery bank and wireless display adapter device 16 providing both charging and wireless display functions to support two-way charging between mobile devices and the wireless display adapter device's own battery, which reduces the number of devices that users have to carry.

5) Add-on features. Various embodiments may provide for many add-on features to be included within the wireless display adapter device 16 such as a BLE beacon and/or a flashlight.

6) Charging options can vary in accordance with various embodiments. Besides USB charging, one or more embodiments may provide for wireless charging and/or powered HDMI (such as a Mobile High-Definition Link (MHL) connection) can also be used for charging.

Compared to existing solutions (e.g., screen mirroring or wireless display products), one or more embodiments of the wireless display adapter device described herein may provide unique advantages to deliver a better user experience.

1) Existing solutions usually require a password to enter the WLAN network or use of a discovery protocol (scan, confirm and connect) to connect a user device to the wireless display adapter device. This is time consuming, especially. in a densely deployed environment. One or more embodiments of wireless display adapter device 16 provide a personal device that can be connected to user device 12 when both devices power up. In fact, in one or more embodiments the connection can be made before wireless display adapter device 16 is connected to the display device 14 (e.g., a projector and/or television (TV)), which makes the perceived user experience nearly instant with zero perceptible connection time. In one or more embodiments, wireless display adapter device also 16 supports a legacy scan protocol for other users to join.

2) Some of the existing solutions require a WLAN connection, which could be cumbersome or slow in the use cases such as meeting in a customers' conference room or staying in a hotel. Various embodiments of the wireless display adapter device 16 do not need any WLAN connection, which enables users to present and share anywhere.

3) Since wireless display adapter device 16 is a battery powered device in one or more embodiments, wireless display adapter device 16 may incorporate unique features that existing solutions cannot provide. A few examples include: a) Bluetooth low energy (BLE) beacons incorporated in the wireless display adapter device can help to easily keep track of user's devices and even other valuables if they are together. It can remind users not to forget their devices after the users share or present; b) depending on the battery power capacity, the wireless display adapter device can also be used as a battery bank that allows two-way charging between phones and the wireless display adapter device. Such a combination design reduces the number of devices that users have to carry.

4) With existing solutions, business users may still need to carry dongles like male to female HDMI connectors, VGA convertors because the prevalent wireless display or screen mirroring devices only have a male HDMI port, which have to be converted before being plugged into the projector/TV cables in the conference rooms. One or more embodiments of the wireless display adapter device address this problem by incorporating female HDMI and VGA connectors in the wireless display adapter device to avoids user hassle.

5). Existing solutions require external power, and hence users have to carry and plug in accessories such as a USB dongle and an AC adapter. Wires and AC outlet location could put constrains on users. Various embodiments of the wireless display adapter device 16 are battery powered, which removes such constraints, frees users up and reduces their burdens of carrying power dongles as well as saving the time of connecting to a power source.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In the discussions of the embodiments above, the capacitors, buffers, graphics elements, interconnect boards, clocks, DDRs, camera sensors, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, non-transitory software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

### Examples

The following examples pertain to further embodiments.

Example 1 is a wireless display adapter device comprising at least one processor and at least one memory element, wherein the wireless display adapter device is configured to: transmit a beacon signal from the wireless display adapter device, wherein the wireless display adapter device is in a sleep mode of operation; receive a connection request from a user device; initiate wake up of the wireless display adapter device from the sleep mode to an active mode responsive to receiving the connection request from the user device; and establish a connection between the wireless display adapter device and the user device using a wireless connection.

In Example 2, the subject matter of Example 1 can optionally include wherein the wireless display adapter device is further configured to: connect the wireless display adapter device to a display device; receive content from the user device; and send the content to the display device.

In Example 3, the subject matter of Example 1 can optionally include wherein the beacon signal further includes include an identifier associated with wireless display adapter device.

In Example 4, the subject matter of Example 1 can optionally include wherein the beacon signal is a Bluetooth low energy signal.

In Example 5, the subject matter of Example 1 can optionally include wherein the connection is a WiFi connection.

In Example 6, the subject matter of Example 2 can optionally include wherein the connection between the wireless display adapter device and the display device is a wired connection.

In Example 7, the subject matter of Example 6 can optionally include wherein the wired connection is one or more of a High-Definition Multimedia Interface (HDMI) connection, a DisplayPort (DP) connection, a Digital Visual Interface (DVI), and a Video Graphics Array (VGA) connection.

Example 8 is at least one non-transitory computer storage medium to store computer code comprising: computer code to transmit a beacon signal from a wireless display adapter device, wherein the wireless display adapter device is in a sleep mode of operation; computer code to receive a connection request from a user device; computer code to initiate wake up of the wireless display adapter device from the sleep mode to an active mode responsive to receiving the connection request from the user device; and computer code to establish a connection between the wireless display adapter device and the user device using a wireless connection.

In Example 9, the subject matter of Example 8 can optionally include computer code to connect the wireless display adapter device to a display device; computer code to receive content from the user device; and computer code to send the content to the display device.

In Example 10, the subject matter of Example 8 can optionally include wherein the beacon signal further includes include an identifier associated with wireless display adapter device.

In Example 11, the subject matter of Example 8 can optionally include wherein the beacon signal is a Bluetooth low energy signal.

In Example 12, the subject matter of Example 8 can optionally include wherein the connection is a WiFi connection.

In Example 13, the subject matter of Example 9 can optionally include wherein the connection between the wireless display adapter device and the display device is a wired connection.

In Example 14, the subject matter of Example 13 can optionally include wherein the wired connection is one or more of a High-Definition Multimedia Interface (HDMI) connection, a DisplayPort (DP) connection, and a Video Graphics Array (VGA) connection.

Example 15 is a computer-implemented method, comprising: transmitting a beacon signal from a wireless display adapter device, wherein the wireless display adapter device is in a sleep mode of operation; receiving a connection request from a user device; initiating wake up of the wireless display adapter device from the sleep mode to an active mode responsive to receiving the connection request from the user device; and establishing a connection between the wireless display adapter device and the user device using a wireless connection.

In Example 16, the subject matter of Example 15 can optionally include connecting the wireless display adapter device to a display device; receiving content from the user device; and sending the content to the display device.

In Example 17, the subject matter of Example 15 can optionally include wherein the beacon signal further includes include an identifier associated with wireless display adapter device.

In Example 18, the subject matter of Example 15 can optionally include wherein the beacon signal is a Bluetooth low energy signal.

In Example 19, the subject matter of Example 15 can optionally include wherein the connection is a WiFi connection.

In Example 20, the subject matter of Example 16 can optionally include wherein the connection between the wireless display adapter device and the display device is a wired connection.

In Example 21, the subject matter of Example 10 can optionally include wherein the wired connection is one or more of a High-Definition Multimedia Interface (HDMI) connection, a DisplayPort (DP) connection, and a Video Graphics Array (VGA) connection.

Example 22 is an apparatus comprising: means for transmitting a beacon signal from a wireless display adapter device, wherein the wireless display adapter device is in a sleep mode of operation; receiving a connection request from a user device; initiating wake up of the wireless display adapter device from the sleep mode to an active mode responsive to receiving the connection request from the user device; and establishing a connection between the wireless display adapter device and the user device using a wireless connection.

In Example 23, the subject matter of Example 22 can optionally include means for connecting the wireless display adapter device to a display device; means for receiving content from the user device; and means for sending the content to the display device.

In Example 24, the subject matter of Examples 22-23 can optionally include wherein the beacon signal further includes include an identifier associated with wireless display adapter device.

In Example 25, the subject matter of Examples 22-23 can optionally include wherein the beacon signal is a Bluetooth low energy signal.

In Example 26, the subject matter of Examples 22-23 can optionally include wherein the connection is a WiFi connection.

In Example 27, the subject matter of Example 22 can optionally include wherein the connection between the wireless display adapter device and the display device is a wired connection.

In Example 28, the subject matter of Example 27 can optionally include wherein the wired connection is one or more of a High-Definition Multimedia Interface (HDMI) connection, a DisplayPort (DP) connection, and a Video Graphics Array (VGA) connection.

Example 29 is a wireless display adapter device comprising at least one processor and at least one memory element, wherein the wireless display adapter device is configured to: transmit a beacon signal from the wireless display adapter device, wherein the wireless display adapter device is in a sleep mode of operation; receive a connection request from a user device; initiate wake up of the wireless display adapter device from the sleep mode to an active mode responsive to receiving the connection request from the user device; and establish a connection between the wireless display adapter device and the user device using a wireless connection.

In Example 30, the subject matter of Example 29 can optionally include wherein the wireless display adapter device is further configured to: connect the wireless display adapter device to a display device; receive content from the user device; and send the content to the display device.

In Example 31, the subject matter of Examples 29-30 can optionally include wherein the beacon signal further includes include an identifier associated with wireless display adapter device.

In Example 32, the subject matter of Examples 29-30 can optionally include wherein the beacon signal is a Bluetooth low energy signal.

In Example 33, the subject matter of Examples 29-30 can optionally include wherein the connection is a WiFi connection.

In Example 34, the subject matter of Example 30 can optionally include wherein the connection between the wireless display adapter device and the display device is a wired connection.

In Example 35, the subject matter of Example 34 can optionally include wherein the wired connection is one or more of a High-Definition Multimedia Interface (HDMI) connection, a DisplayPort (DP) connection, a Digital Visual Interface (DVI), and a Video Graphics Array (VGA) connection.

Example 36 is at least one non-transitory computer storage medium to store computer code comprising: computer code to transmit a beacon signal from a wireless display adapter device, wherein the wireless display adapter device is in a sleep mode of operation; computer code to receive a connection request from a user device; computer code to initiate wake up of the wireless display adapter device from the sleep mode to an active mode responsive to receiving the connection request from the user device; and computer code to establish a connection between the wireless display adapter device and the user device using a wireless connection.

In Example 37, the subject matter of Example 36 can optionally include computer code to connect the wireless display adapter device to a display device; computer code to receive content from the user device; and computer code to send the content to the display device.

In Example 38, the subject matter of Examples 36-37 can optionally include wherein the beacon signal further includes include an identifier associated with wireless display adapter device.

In Example 39, the subject matter of Examples 36-37 can optionally include wherein the beacon signal is a Bluetooth low energy signal.

In Example 40, the subject matter of Examples 36-37 can optionally include wherein the connection is a WiFi connection.

In Example 41, the subject matter of Example 36 can optionally include wherein the connection between the wireless display adapter device and the display device is a wired connection.

In Example 42, the subject matter of Example 41 can optionally include wherein the wired connection is one or more of a High-Definition Multimedia Interface (HDMI) connection, a DisplayPort (DP) connection, and a Video Graphics Array (VGA) connection

Example 43 is a computer-implemented method, comprising: transmitting a beacon signal from a wireless display adapter device, wherein the wireless display adapter device is in a sleep mode of operation; receiving a connection request from a user device; initiating wake up of the wireless display adapter device from the sleep mode to an active mode responsive to receiving the connection request from the user device; and establishing a connection between the wireless display adapter device and the user device using a wireless connection.

In Example 44, the subject matter of Example 43 can optionally include connecting the wireless display adapter device to a display device; receiving content from the user device; and sending the content to the display device.

In Example 45, the subject matter of Examples 43-44 can optionally include wherein the beacon signal further includes include an identifier associated with wireless display adapter device.

In Example 46, the subject matter of Examples 43-44 can optionally include wherein the beacon signal is a Bluetooth low energy signal.

In Example 47, the subject matter of Examples 43-44 can optionally include wherein the connection is a WiFi connection.

In Example 48, the subject matter of Example 44 can optionally include wherein the connection between the wireless display adapter device and the display device is a wired connection.

In Example 49, the subject matter of Example 48 can optionally include wherein the wired connection is one or more of a High-Definition Multimedia Interface (HDMI) connection, a DisplayPort (DP) connection, and a Video Graphics Array (VGA) connection.

Example 50 is a method, comprising: transmitting a beacon signal from a wireless display adapter device, wherein the wireless display adapter device is in a sleep mode of operation; receiving a connection request from a user device; initiating wake up of the wireless display adapter device from the sleep mode to an active mode responsive to receiving the connection request from the user device; and establishing a connection between the wireless display adapter device and the user device using a wireless connection.

In Example 51, the subject matter of Example 50 can optionally include connecting the wireless display adapter device to a display device; receiving content from the user device; and sending the content to the display device.

In Example 52, the subject matter of Examples 50-51 can optionally include wherein the beacon signal further includes include an identifier associated with wireless display adapter device.

In Example 53, the subject matter of Examples 50-51 can optionally include wherein the beacon signal is a Bluetooth low energy signal.

In Example 54, the subject matter of Examples 50-51 can optionally include wherein the connection is a WiFi connection.

In Example 55, the subject matter of Example 51 can optionally include wherein the connection between the wireless display adapter device and the display device is a wired connection.

In Example 56, the subject matter of Example 55 can optionally include wherein the wired connection is one or more of a High-Definition Multimedia Interface (HDMI) connection, a DisplayPort (DP) connection, and a Video Graphics Array (VGA) connection.

Example 57 is an apparatus comprising means for performing the method of any of the preceding Examples.

In Example 58, the subject matter of Example 57 can optionally include wherein the means for performing the method comprise a processor and a memory.

In Example 59, the subject matter of Examples 50-55 can optionally include wherein the memory comprises machine-readable instructions, that when executed cause the apparatus to perform the method of any of Examples 50-55.

In Example 60, the subject matter of Examples 57-59 can optionally include wherein the apparatus is a computing system.

Example 61 is at least one computer readable medium comprising instructions that, when executed, implement a method or realize an apparatus as found in any preceding Example.

What is claimed is:

1. A wireless display adapter device comprising at least one processor and at least one memory element, wherein the wireless display adapter device is configured to:
transmit a beacon signal from the wireless display adapter device, wherein the wireless display adapter device is in a sleep mode of operation;
receive a connection request from a user device;
initiate wake up of the wireless display adapter device from the sleep mode to an active mode responsive to receiving the connection request from the user device; and
establish a connection between the wireless display adapter device and the user device using a wireless connection.

2. The wireless display adapter device of claim 1, wherein the wireless display adapter device is further configured to:
connect the wireless display adapter device to a display device;
receive content from the user device; and
send the content to the display device.

3. The wireless display adapter device of claim 1, wherein the beacon signal further includes include an identifier associated with wireless display adapter device.

4. The wireless display adapter device of claim 1, wherein the beacon signal is a Bluetooth low energy signal.

5. The wireless display adapter device of claim 1, wherein the connection is a WiFi connection.

6. The wireless display adapter device of claim 2, wherein the connection between the wireless display adapter device and the display device is a wired connection.

7. The wireless display adapter device of claim 6, wherein the wired connection is one or more of a High-Definition Multimedia Interface (HDMI) connection, a DisplayPort (DP) connection, a Digital Visual Interface (DVI), and a Video Graphics Array (VGA) connection.

8. At least one non-transitory computer storage medium to store computer code comprising:
computer code to transmit a beacon signal from a wireless display adapter device, wherein the wireless display adapter device is in a sleep mode of operation;
computer code to receive a connection request from a user device;
computer code to initiate wake up of the wireless display adapter device from the sleep mode to an active mode responsive to receiving the connection request from the user device; and
computer code to establish a connection between the wireless display adapter device and the user device using a wireless connection.

9. The at least one non-transitory computer storage medium of claim 8, further comprising:
computer code to connect the wireless display adapter device to a display device;
computer code to receive content from the user device; and
computer code to send the content to the display device.

10. The at least one non-transitory computer storage medium of claim 8, wherein the beacon signal further includes include an identifier associated with wireless display adapter device.

11. The at least one non-transitory computer storage medium of claim 8, wherein the beacon signal is a Bluetooth low energy signal.

12. The at least one non-transitory computer storage medium of claim 8, wherein the connection is a WiFi connection.

13. The at least one non-transitory computer storage medium of claim 9, wherein the connection between the wireless display adapter device and the display device is a wired connection.

14. The at least one non-transitory computer storage medium of claim 13, wherein the wired connection is one or more of a High-Definition Multimedia Interface (HDMI) connection, a DisplayPort (DP) connection, and a Video Graphics Array (VGA) connection.

15. A computer-implemented method, comprising:
transmitting a beacon signal from a wireless display adapter device, wherein the wireless display adapter device is in a sleep mode of operation;
receiving a connection request from a user device;
initiating wake up of the wireless display adapter device from the sleep mode to an active mode responsive to receiving the connection request from the user device; and
establishing a connection between the wireless display adapter device and the user device using a wireless connection.

16. The computer-implemented method of claim 15, further comprising:
connecting the wireless display adapter device to a display device;
receiving content from the user device; and
sending the content to the display device.

17. The computer-implemented method of claim 15, wherein the beacon signal further includes include an identifier associated with wireless display adapter device.

18. The computer-implemented method of claim 15, wherein the beacon signal is a Bluetooth low energy signal.

19. The computer-implemented method of claim 15, wherein the connection is a WiFi connection.

20. The computer-implemented method of claim 16, wherein the connection between the wireless display adapter device and the display device is a wired connection.

21. The computer-implemented method of claim 20, wherein the wired connection is one or more of a High-Definition Multimedia Interface (HDMI) connection, a DisplayPort (DP) connection, and a Video Graphics Array (VGA) connection.
